(19) United States
(12) Patent Application Publication
(10) Pub. No.: US 2017/0139506 A1
(43) Pub. Date: May 18, 2017

(54) PLASTIC MOULDING WITH SEAMLESS HUMAN-TO-VEHICLE INTERFACE INTEGRATION

(71) Applicant: SRG Global Liria, S.L.U., Valencia (ES)

(72) Inventors: Fernando Colón Rodríguez, Valencia (ES); Javier Grandia Rodrigo, Valencia (ES)

(73) Assignee: SRG Global Liria, S.L.U., Valencia (ES)

(21) Appl. No.: 15/351,947

(22) Filed: Nov. 15, 2016

(30) Foreign Application Priority Data
Nov. 16, 2015 (EP) 15382568.2

(51) Int. Cl. G06F 3/044; B60R 25/23; B62D 25/04; G06F 3/0488; B29C 45/14

(52) U.S. Cl. CPC G06F 3/044; G06F 3/04883; B29C 45/14688; B62D 25/04; B60R 25/23; G06F 2203/04103; B29C 2045/14704; B29K 2075/00

(57) ABSTRACT

A pillar assembly for a vehicle can include a substrate, a transparent layer, and a transparent flexible film layer sealed between the substrate and the transparent layer. The film layer can have disposed thereon or attached thereto an opaque material defining apertures corresponding to displayable elements, a capacitive-sensing layer, a plurality of light emitting devices disposed proximate to the apertures, and wiring connected to the plurality of light emitting devices and the capacitive-sensing layer, the wiring being configured to connect to control circuitry. A method of manufacturing a pillar assembly can utilize two separate film layers with a transparent or translucent polymer injected therebetween and a transparent material, such as polyurethane, flooded over an outer surface.

### CROSS-REFERENCE TO RELATED APPLICATIONS

This application claims the benefit of European Patent Application No. 15382568.2, filed Nov. 16, 2015. The disclosure of the above application is incorporated herein by reference in its entirety.

### FIELD

The present disclosure generally relates to vehicle pillars and, more particularly, to a vehicle pillar having a plastic moulding/molding with seamless human-to-vehicle interface integration.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A vehicle can include a plurality of vertical supports for its window area or cabin. These supports are commonly referred to as pillars. Each pillar can correspond to a particular position from a front to a rear of the window area. More particularly, a first pillar near a front of the vehicle's windshield can be referred to as an A-pillar and a second pillar after the vehicle's front passenger window can be referred to as a B-pillar. Depending on the configuration of the vehicle (i.e., a number of other sets of passenger windows), there can be some or no other intermediary pillars before a last pillar near a rear of the vehicle's rear windshield (e.g., a C-pillar for a conventional coupe or sedan). In addition to providing structural support for the vehicle, these pillar assemblies may incorporate other vehicle components.

### SUMMARY

According to another aspect of the present disclosure, a pillar assembly for a vehicle and its method of manufacture are presented. In one exemplary implementation, the method can comprise obtaining a first film layer; forming decorative features with respect to a first side of the first film layer and applying conductive ink to an opposing second side of the first film layer to obtain a modified first film layer; obtaining a separate second film layer; at least one of printing and attaching electronic elements to a first side of the second film layer to obtain a modified second film layer, the electronic elements including light-emitting devices; injecting a transparent or translucent polymer between the second side of the modified first film layer and the first side of the modified second film layer; and after injecting the transparent or translucent polymer, flooding a material over the first side of the modified first film layer to form a transparent layer.

In some implementations, the method can further comprise obtaining a pillar insert comprising the modified first film layer, the modified second film layer, and the transparent or translucent polymer therebetween, and using the pillar insert as an insert for injection molding another component to form the pillar assembly, wherein the flooding is performed after forming the pillar assembly.

In some implementations, the first film layer is opaque, and the decorative features correspond to at least one of apertures, colors, and opaque/transparent ink mixtures defined by the modified first film layer. In other implementations, the first film layer is transparent or translucent, and the decorative features correspond to portions of the first side of the modified first film layer that are not covered by an opaque ink or material.

In some implementations, the material used in the flooding is polyurethane.

In some implementations, the electronic elements further include (i) first wiring connected to the light-emitting devices and configured to be connected to control circuitry and (ii) second wiring connected to the conductive ink and configured to be connected to the control circuitry.

In some implementations, the decorative features, when illuminated by the light-emitting devices, represent at least one of numbers, letters, and symbols.

In some implementations, the injection molding of the other component includes forming at least a back piece or substrate for the pillar assembly, the back piece or substrate being formed of the transparent or translucent polymer or a different material.

According to another aspect of the present disclosure, a pillar assembly for a vehicle and its method of manufacture are presented. In one exemplary implementation, the pillar assembly can comprise a substrate, a transparent layer, and a transparent flexible film layer sealed between the substrate and the transparent layer, the film layer having disposed thereon or attached thereto: an opaque material defining apertures corresponding to displayable elements; a capacitive-sensing layer; a plurality of light emitting devices disposed proximate to the apertures; and wiring connected to the plurality of light emitting devices and the capacitive-sensing layer, the wiring being configured to connect to control circuitry.

In some implementations, the substrate is a thermoplastic polymer and the transparent layer is a thermoplastic. In some implementations, the thermoplastic polymer substrate comprises acrylonitrile butadiene styrene (ABS), and the transparent thermoplastic layer comprises polymethyl methacrylate (PMMA)

In other implementations, the transparent layer is formed using a flooding process. In some implementations, the transparent layer comprises polyurethane.

In some implementations, when activated, the plurality of light emitting devices are configured to illuminate the displayable elements for viewing by a user. In some implementations, at least one of the capacitive-sensing layer and the control circuitry are configured to capture a touch input or a gesture from a user.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A-1D illustrate a conventional vehicle pillar assembly incorporating a touchpad system according to the prior art;

FIGS. 2A-2B illustrate the touchpad system of FIG. 1 and user interaction therewith;

FIG. 3 is a cross-sectional view of an example vehicle pillar assembly incorporating a touchpad system according to some implementations of the present disclosure;

FIGS. 4A-4B are perspective views of the example vehicle pillar assembly of FIG. 3;

FIG. 5 is a flow diagram of an example method for manufacturing a vehicle pillar assembly incorporating a touchpad system according to some implementations of the present disclosure;

FIG. 6 is a cross-sectional view of another example vehicle pillar assembly incorporating a touchpad system according to some implementations of the present disclosure; and

FIG. 7 is a flow diagram of another example method for manufacturing a vehicle pillar assembly incorporating a touchpad system according to some implementations of the present disclosure.

### DETAILED DESCRIPTION

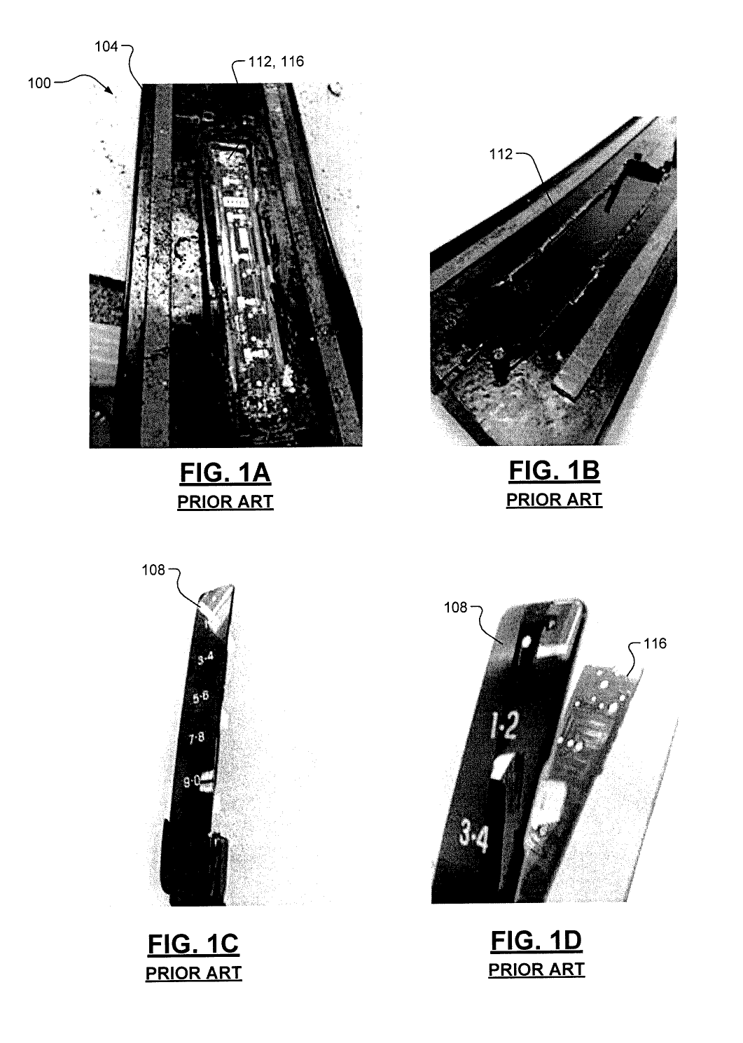

As previously mentioned, vehicle pillar assemblies may incorporate other vehicle components. One such component is a touchpad system. This touchpad system could be for receiving a key code (e.g., a combination of digits 0-9 and/or other characters) for unlocking the vehicle, such as when the driver doesn't want to use her/his keys or when she/he is otherwise locked out of the vehicle. Such a system could be incorporated in the B-pillar, for example, due to its proximity to the vehicle's driver door. A conventional pillar assembly including a touchpad system is illustrated in FIGS. 1A-1D. The assembly 100 can include a substrate 104 and a transparent cover layer 108. FIGS. 1A-1B illustrate a back view of the substrate 104 with and without a touchpad system 116 and FIGS. 1C-1D illustrate a front view of the transparent cover layer 108 and the touchpad system 116.

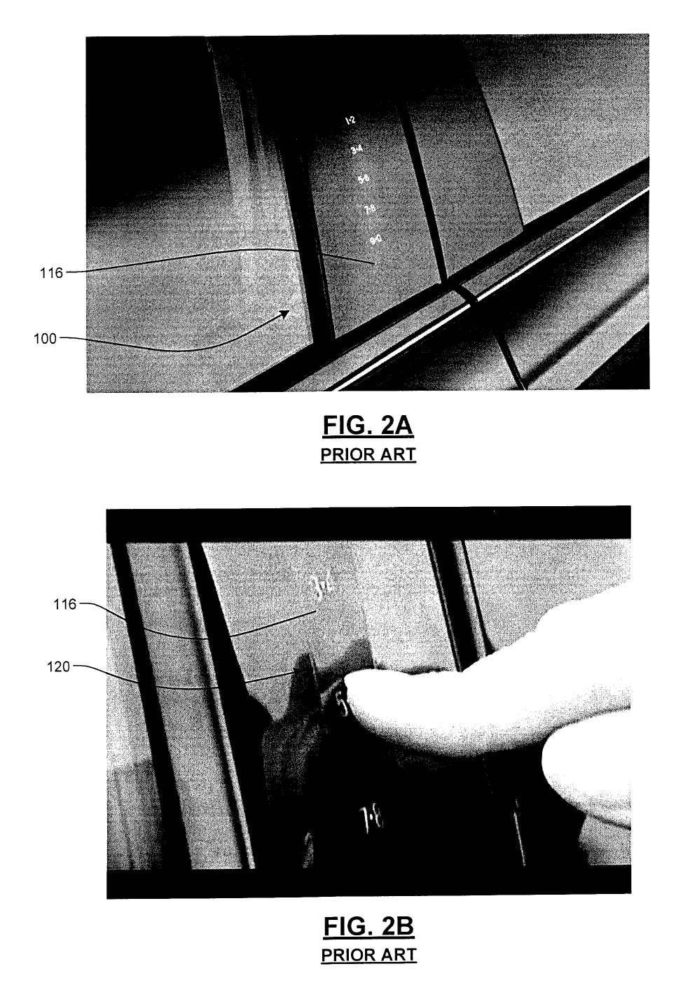

The substrate 104 can define an aperture 112 in which the touchpad system 116 can be disposed. To prevent moisture and/or dust from affecting operation of the touchpad system 116, the touchpad system 116 or the entire assembly 100 can be sealed using additional sealant materials. Because the touchpad system 116 is a separate system disposed in the aperture 112 of the substrate 104, however, the touchpad system 116 may be visible to a user. FIGS. 2A-2B illustrate the touchpad system 116 and user interaction therewith. As can be seen, the touchpad system 116 is clearly visible to a user, even when not being operated (e.g., illuminated). Moreover, as shown in FIG. 2B, the touchpad system 116 is bulky and may be very deformable in response to the user's touch (see 120). This visibility and tactile feel of the touchpad system 116 is not desirable for the user.

Accordingly, a plastic moulding/molding with seamless human-to-vehicle interface integration is presented. In one exemplary implementation, the plastic molding is a B-pillar assembly that incorporates a touchpad system for human-to-vehicle interfacing, but it will be appreciated that the systems/methods of the present disclosure can be applicable to other vehicle pillar assemblies (e.g., A or C pillar assemblies) as well as other vehicle components or consumer electronics. The presented pillar assembly can be thinner and less bulky than conventional pillar assemblies incorporating touchpad systems. These pillar assemblies can also be less or non-visible to the user when inactive/non-illuminated, and can also provide for a better tactile feel for the user (e.g., a less deformable response when pressed by bringing the capacitive-sensing layer closer to the user and decreasing the number of intermediate layers). Further, by incorporating at least some of the touchpad system components (e.g., opaque graphics, conductive layer, light sources, etc.) on a thin, transparent flexible film layer, the B-pillar assembly can be formed by injection molding the substrate layer and the transparent layer with the film layer sealed therebetween. This can eliminate the need for multiple intermediary layers and additional sealing materials to protect the touchpad system from moisture and/or dust. Further, the printed circuits on the film layer can be tested at any point up until the final assembly forming process (e.g., the very last moment before the end of the injection molding process).

While injection molding is specifically discussed herein, it will be appreciated that other processes could be utilized to form at least a portion of the assembly. For example, and as discussed in greater detail later herein, a flooding process could be utilized where the pillar is covered with a very thin (e.g., compared to other manufacturing processes) transparent layer, such as polyurethane. More particularly, the pillar could be inserted into a mold or container and a liquid material (e.g., polyurethane) can be poured into the mold/container, thereby “flooding” the pillar. After setting, the flooding material will be a very thin layer attached to the pillar. In some cases, the entire pillar could be flooded, thereby sealing the pillar within the flooding material. This could provide for improved resistance for the pillar assembly to moisture and other environmental conditions.

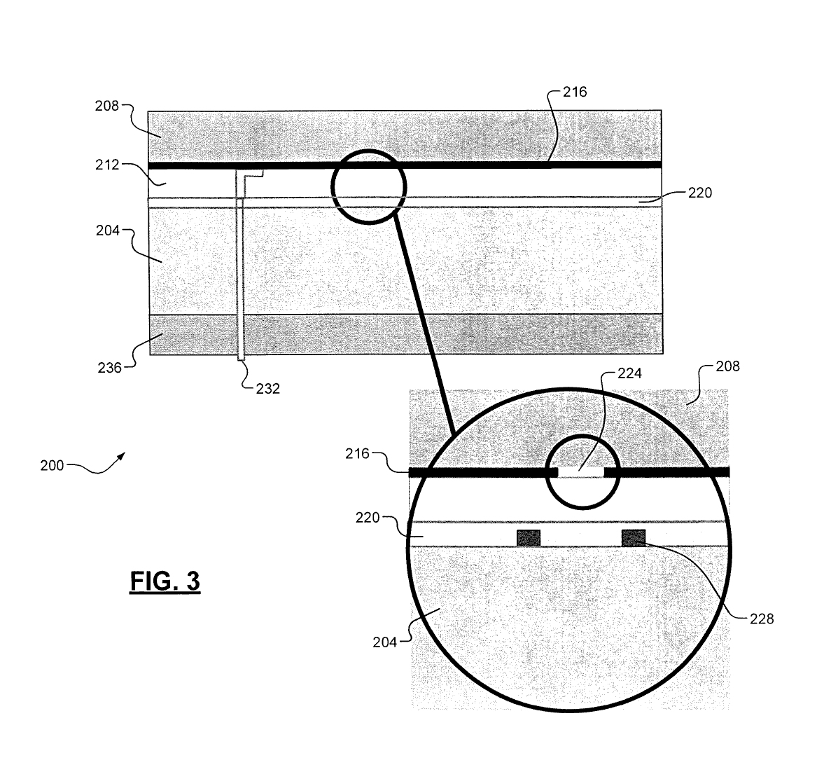

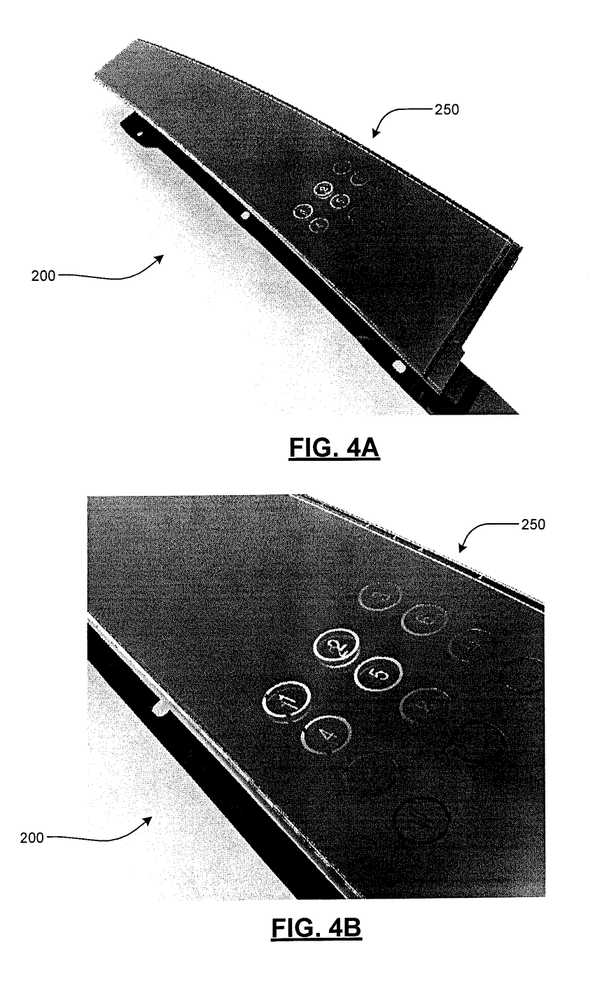

Referring now to FIGS. 3 and 4A-4B, cross-sectional view and perspective views of an example pillar assembly 200 according to some implementations of the present disclosure are illustrated. While a pillar assembly is discussed herein, it will be appreciated that the pillar assembly 200 may be only a portion of a full pillar assembly that includes other components (e.g., structural metal). The assembly 200 can include a base layer or substrate 204. In some implementations, the substrate is a thermoplastic polymer, such as acrylonitrile butadiene styrene (ABS), but it will be appreciated that other materials could be utilized. The assembly 200 can also include a top or transparent layer 208, such as polymethyl methacrylate (PMMA), also known as acrylic or acrylic glass, but it will be appreciated that other transparent or semi-transparent materials could be utilized (e.g., polyurethane). The choice of materials can be made to provide for good chemical adherence between the substrate, the film layer, and the transparent layer, thereby providing for the requisite mechanical properties while also isolating function of the film layer (e.g., the touchpad system components). Disposed between the substrate 204 and the transparent layer 208 can be an intermediate film layer 212.

This film layer 212 can be a thin flexible transparent layer having at least some of the components of a touchpad system disposed thereon. For example, at least some of these components can be printed circuit components on the film layer 212. In some implementations, these components can include a graphics layer 216 comprising an opaque material (e.g., a black, non-conductive ink) disposed between the transparent layer 208 and the film layer 212. The opaque graphics layer 216 can define a plurality of transparent portions or apertures 224 corresponding to displayable elements (digits 0-9, alphabetical characters, non-alphabetic symbols, etc.) for the touchpad system. In some implementations, these components can also include a capacitive-sensing or conductive layer 220 disposed between the substrate 204 and the film layer 212. This capacitive-sensing layer 220 can be configured to receive a touch input from a user (e.g., to input a key code in an attempt to unlock the vehicle). A zoomed-in portion of the cross-sectional view illustrates one of the plurality of apertures 224 in the opaque graphics layer 216. In some implementations, the opaque graphics layer 216 can also define a desired color of the system.

The conductive layer 220 can also have light sources 228 (e.g., light-emitting diodes or LEDs) disposed thereon. The light sources 228, when illuminated, can provide back-lighting that can illuminate the displayable elements by emitting light through the apertures 224 of the opaque graphics layer 216 (see FIGS. 4A-4B at 250). Wiring 232 can be coupled to the light sources 228 and the conductive layer 220. The wiring 232 can also be coupled to control circuitry, such as a printed circuit board (PCB) and/or an electronic control unit (ECU), shown as layer 236. For example, the wiring 232 may be run through the substrate 204. While the control circuitry 236 (e.g., PCB/ECU) is shown as being disposed as a layer behind the substrate 204, it will be appreciated that these components could be located at another location, such as to further decrease the thickness of the assembly 100. In some implementations, the control circuity 236 is a thin PCB coupled to the back of the substrate 204.

It will also be appreciated that the control circuitry 236 can include one or more communication devices, such as near field communication (NFC) device and/or a Bluetooth low-energy (BLE) device. Implementing such communication devices enables interoperability between the control circuitry 236 and other devices, such as user smartphones, tablets, and wearable computing devices (smartwatches, smart eyewear, etc.). This can improve the functionality of the pillar assembly 200 (e.g., by enabling a user to unlock the vehicle via his/her smartphone). In addition to providing discrete touch inputs that are captured by the capacitive-sensing layer, it will be appreciated that the user could input a slide input pattern (e.g., using a single touch input without breaking contact with the pillar assembly). It will also be appreciated that the user could provide a gesture or a pattern of gestures (e.g., a wave of the user's hand) without physically touching the pillar assembly, and these gesture(s) could be interpreted by the capacitive-sensing layer 220 and/or the communication device(s).

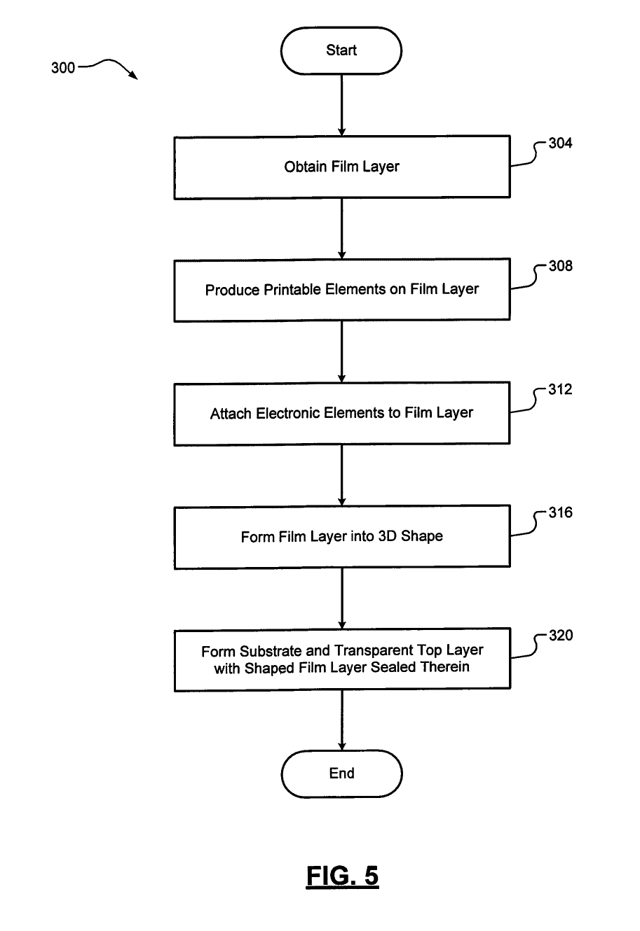

Referring now to FIG. 5, a flow diagram of an example method 300 for manufacturing the vehicle pillar assembly 200 according to some implementations of the present disclosure is illustrated. At 304, the film layer 212 is obtained. At 308, printed components (e.g., the conductive layer 220, the opaque graphics layer 216, and/or a portion of the wiring 232) are produced on the film layer 212, such as via screen printing or any other suitable process. At 312, electronic elements (e.g., the light sources 228 and/or a portion of the wiring 232) are attached to the film layer 212. At 316, the film layer 212 is formed into a three-dimensional shape (e.g., a slightly curved elongate shape). Example shape forming processes can include vacuum and pressure thermoforming, although it will be appreciated that other techniques can be utilized. It will be appreciated that step 316 can be optional. In other words, depending on the design of the final pillar assembly, the film layer 212 may or may not need to be pre-formed prior to injection molding. At 320, the film layer 212 is injection molded into the pillar assembly 200. Further, while a pillar assembly is shown and discussed herein, it will be appreciated that the system/method of the present disclosure could be similarly applied to other vehicle pillars or other vehicle structures (e.g., a vehicle tailgate).

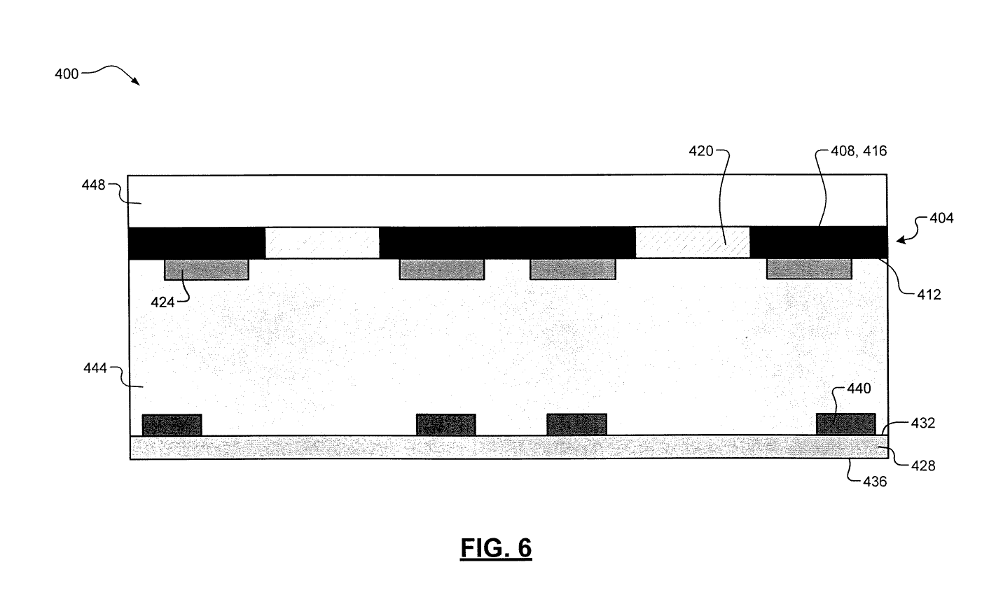

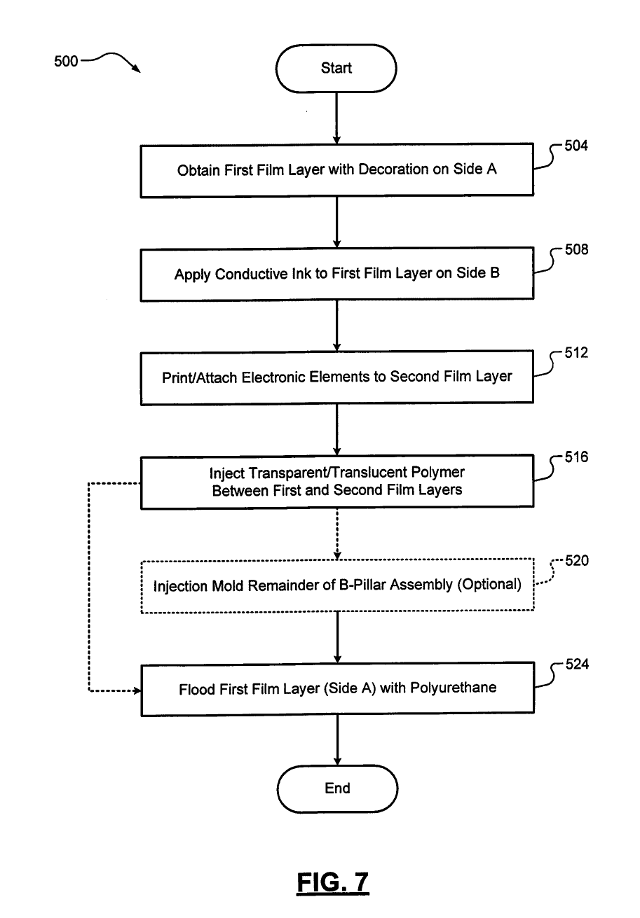

Referring now to FIGS. 6-7, a cross-sectional view of another example pillar insert 400 and a flow diagram of an example method 500 for its manufacture are illustrated. At 504, a first film layer 404 having decorative features is obtained. This first film layer 404 can define two sides: side A 408 and side B 412. The decorative features of the first film layer 404 can be defined by various opaque regions 416 and translucent or transparent regions 420. For a translucent or semi-transparent region, for example, transparent inks could be mixed with opaque inks used for the decoration, thereby creating a translucent or semi-transparent ink for the regions 420. When not fully-transparent, these regions 420 may provide a “hidden until lit” effect. In other words, these regions 420 may not be readily visible to the user until the backlighting is activated. This seamless integration may provide for a more aesthetically pleasing design. Instead of translucent or transparent regions 420, the first film layer 404 could be completely opaque, but could further define apertures in place of the translucent or transparent regions 420. For example only, the first film layer 404 could be transparent and a mask could be applied thereto, after which an opaque ink or other material could be applied to side A 408 of the first film layer 404. At 508, conductive ink or capacitive sensing layer 424 can be applied to side B 412 of the first film layer 404. It will be appreciated that steps 504 and 508 could be performed in either order, although the conductive ink or capacitive sensing layer 424 may need to be arranged with respect to the decorative features.

At 512, a second film layer 428 is obtained and, on its side A 432 (as opposed to its side B 436), electronic elements are printed thereon or otherwise attached thereto. While these electronic elements are illustrated as light-emitting devices 440, it will be appreciated that additional circuitry (e.g., wiring) could be printed/attached to the A side 432 of the second film layer 428. For example, first wiring could attach to the light-emitting devices 440 and second wiring could attach to the capacitive sensing layer 424, and these wirings could be configured to be attached to control circuitry. In some implementations, the first film layer 404 and the second film layer 428 are electrically connected, such as by adding metallic springs attached to both films 404, 428 with conductive adhesive and conductive inks. At 516, a transparent/translucent polymer layer 444 is injected between the first film layer 404 and the second film layer 428 as shown.

At optional 520, the remainder of the pillar assembly is injection molded. This step could also include shaping the pillar insert 400 to a desired three-dimensional shape (e.g., a curved piece). For example, the pillar insert 400 can be used as an insert to a mold and other components can be injection molded (e.g., a back piece or substrate formed of ABS or another suitable material) to obtain a final pillar assembly. This could also include forming a transparent cover piece (e.g., formed of PMMA), thereby sealing the pillar insert 400 therein. In one exemplary implementation, these other component(s) could be formed of the same transparent or translucent polymer/plastic as layer 444. In such an implementation, for example, the other component(s) and layer 444 could be formed during a same molding shot at step 516. Thus, step 520 may not be required. Such a design could decrease manufacturing time/resources. Lastly, at 524, A-side 408 of the first film layer 404 is flooded with a material (e.g., polyurethane) to form a transparent layer 448 of the final pillar assembly. The method 500 can then end.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of manufacturing a pillar assembly for a vehicle, the method comprising:
obtaining a first film layer;
forming decorative features with respect to a first side of the first film layer and applying conductive ink to an opposing second side of the first film layer to obtain a modified first film layer;
obtaining a separate second film layer;
at least one of printing and attaching electronic elements to a first side of the second film layer to obtain a modified second film layer, the electronic elements including light-emitting devices;
injecting a transparent or translucent polymer between the second side of the modified first film layer and the first side of the modified second film layer; and
after injecting the transparent or translucent polymer, flooding a material over the first side of the modified first film layer to form a transparent layer.

2. The method of claim 1, further comprising:
obtaining a pillar insert formed of the modified first film layer, the modified second film layer, and the transparent or translucent polymer therebetween; and
using the pillar insert as an insert for injection molding another component to form the pillar assembly,
wherein the flooding is performed after forming the pillar assembly.

3. The method of claim 1, wherein the first film layer is opaque, and wherein the decorative features correspond to apertures defined by the modified first film layer.

4. The method of claim 1, wherein the first film layer is transparent or translucent, and wherein the decorative features correspond to portions of the first side of the modified first film layer that are not covered by an opaque ink or material.

5. The method of claim 1, wherein the material used in the flooding is polyurethane.

6. The method of claim 1, wherein the electronic elements further include (i) first wiring connected to the light-emitting devices and configured to be connected to control circuitry and (ii) second wiring connected to the conductive ink and configured to be connected to the control circuitry.

7. The method of claim 1, wherein the decorative features, when illuminated by the light-emitting devices, represent at least one of numbers, letters, and symbols.

8. The method of claim 1, wherein the injection molding of the other component includes forming at least a back piece or substrate for the pillar assembly, the back piece or substrate being formed of either the transparent or translucent polymer or a different material.

9. A pillar assembly for a vehicle, the pillar assembly comprising:
a substrate;
a transparent layer; and
a transparent flexible film layer sealed between the substrate and the transparent layer, the film layer having disposed thereon or attached thereto:
an opaque material defining transparent portions or apertures corresponding to displayable elements;
a capacitive-sensing layer;
a plurality of light emitting devices disposed proximate to the apertures; and
wiring connected to the plurality of light emitting devices and the capacitive-sensing layer, the wiring being configured to connect to control circuitry.

10. The pillar assembly of claim 9, wherein the substrate is a thermoplastic polymer and the transparent layer is a thermoplastic.

11. The pillar assembly of claim 10, wherein the thermoplastic polymer substrate comprises acrylonitrile butadiene styrene (ABS), and wherein the transparent thermoplastic layer comprises polymethyl methacrylate (PMMA).

12. The pillar assembly of claim 9, wherein the transparent layer is formed using a flooding process.

13. The pillar assembly of claim 12, wherein the transparent layer comprises polyurethane.

14. The pillar assembly of claim 9, wherein, when activated, the plurality of light emitting devices are configured to illuminate the displayable elements for viewing by a user.

15. The pillar assembly of claim 9, wherein at least one of the capacitive-sensing layer and the control circuitry are configured to capture a touch input or a gesture from a user.
